(19) United States
(12) Patent Application Publication
(10) Pub. No.: US 2019/0365136 A1
(43) Pub. Date: Dec. 5, 2019

(54) Coffee Press

(71) Applicant: Kitchen Gizmo, Inc., Brooklyn, NY (US)

(72) Inventor: Joshua Farkas, Brooklyn, NY (US)

(73) Assignee: Kitchen Gizmo, Inc., Brooklyn, NY (US)

(21) Appl. No.: 15/991,103

(22) Filed: May 29, 2018

(51) Int. Cl. A47J 31/20

(52) U.S. Cl. CPC A47J 31/20

(57) ABSTRACT

The present invention provides a novel system whereby an upper press plate a contact plate and a lower press plate are utilized in a French press coffee brewing system.

### BACKGROUND OF THE INVENTION

A French press, also known as a cafetière, cafetière a piston, Cafeteria, press pot, coffee press, or coffee plunger, is a coffee brewing device.

Typically, in using the press, coffee is brewed by placing coarsely ground coffee in the empty beaker and adding hot—between 93-96° C. (199-205° F.)—water, in proportions of about 30 g (1.1 oz) of coffee grounds to 500 ml (17 US fl oz) of water, more or less to taste. The brewing time is about two to four minutes. Then the mesh plunger or piston is pressed, to separate the grounds and hold them at the bottom of the beaker. The mesh piston normally does not compress the coffee grounds, as most designs leave a generous space—about 30 mm (1.2 in)—below the piston in its lowest position. If the brewed coffee is allowed to remain in the beaker with the used grounds, the coffee may become astringent and bitter, though this is an effect that some users of the French press consider desirable.

A French press works best with coffee of a coarser grind than does a drip brew coffee, about the consistency of kosher salt. Finer grounds, when immersed in water, have lower permeability, requiring an excessive amount of force to be applied by hand to lower the plunger and are more likely to seep through or around the perimeter of the press filter and into the coffee. Additionally, finer grounds will tend to over-extract and cause the coffee to taste bitter.

Although the French press has a particular level of popularity, there are numerous issues users typically encounter.

These issues can be anyone or all of the following:

since the filter is porous, the hot water stays in contact with the coffee grinds. As long as hot water is exposed to coffee grinds, it will keep on extracting. This often results in an over extracted bitter tasting brew.

This requires a user to completely empty the coffee immediately after filtration. Often, this is not desired or practical.

Additionally, it often occurs that coffee grinds passed through the sides of the filter. In doing so, finally ground matter or silt typically ends up in coffee that is served. This is also unwanted and undesired.

The present invention has provided a novel assembly to improve this well-known and well-liked device.

### SUMMARY OF THE INVENTION

The present invention provides a novel configuration utilizing a pair of press plates separated by internal springs. The press plates separate when pressure is released and a pair of silicon rings limit the time in which hot water is in contact with coffee, tea, or any other solid utilized in the brewing and preparation process.

In one embodiment, plates are pushed down and water passes through the system and contacts coffee positioned therein. When the pressure is released, the spring urges a contact plate and upper press plate upward and seals off the bottom of the carafe. This ensures that no hot water touches the ground after filtration and prevents over extraction from prolonged exposure to the hot water.

In one embodiment, the present invention is a coffee press system comprising:
an upper press plate with an outer silicon sealing ring positioned around the circumference edge of said upper press plate;

a contact plate on the underside of said upper press plate positioned, wherein said contact plate has an inner silicon sealing ring positioned around the circumferential edge of said contact plate;

a lower press plate position below said upper press plate and said contact plate, said lower plate formed with a pair of spring walls and circumferential spring formed about the circumferential edge of said lower press plate;

a screen or mesh positioned upward from and above said lower press plate, said screen constructed and arranged to contain solid particulate between said contact plate and lower press plate when the system is in use; and

a spring-loaded central shaft positioned between said lower press plate and said contact plate whereby said spring-loaded central shaft is urged upward from said lower press plate towards said contact plate by a central spring.

In one embodiment, the present invention further comprises a container constructed and arranged to mate with said system. In one embodiment, of the present invention, said screen or mesh is urged outward from the center of said system by a mesh spring.

In one embodiment, of the present invention said central spring includes one or more springs acting in concert.

In one embodiment, of the present invention is a method of preparing coffee, said method comprising the steps of: providing a system as described herein;

adding coffee to said system on top of said lower press plate;

positioning said system in a container of water, wherein said container is constructed and arranged to receive said system;

applying pressure on said central spring from a direction above said system in a direction of said lower press plate;

maintaining said applying of pressure for time between 30 and 300 seconds;

removing said system from said container while maintaining pressure.

In one embodiment, the present invention is a coffee press system consisting essentially of:
an upper press plate with an outer silicon sealing ring positioned around the circumference edge of said upper press plate;

a contact plate on the underside of said upper press plate positioned, wherein said contact plate has an inner silicon sealing ring positioned around the circumferential edge of said contact plate;

a lower press plate position below said upper press plate and said contact plate, said lower plate formed with a pair of spring walls and circumferential spring formed about the circumferential edge of said lower press plate;

a screen or mesh positioned upward from and above said lower press plate, said screen constructed and arranged to contain solid particulate between said contact plate and lower press plate when the system is in use; and

a spring-loaded central shaft positioned between said lower press plate and said contact plate whereby said spring-loaded central shaft is urged upward from said lower press plate towards said contact plate by a central spring.

### BRIEF DESCRIPTION OF THE SEVERAL VIEWS OF THE DRAWINGS

FIG. 1 is a perspective view of the press plates according to one embodiment of the present invention.

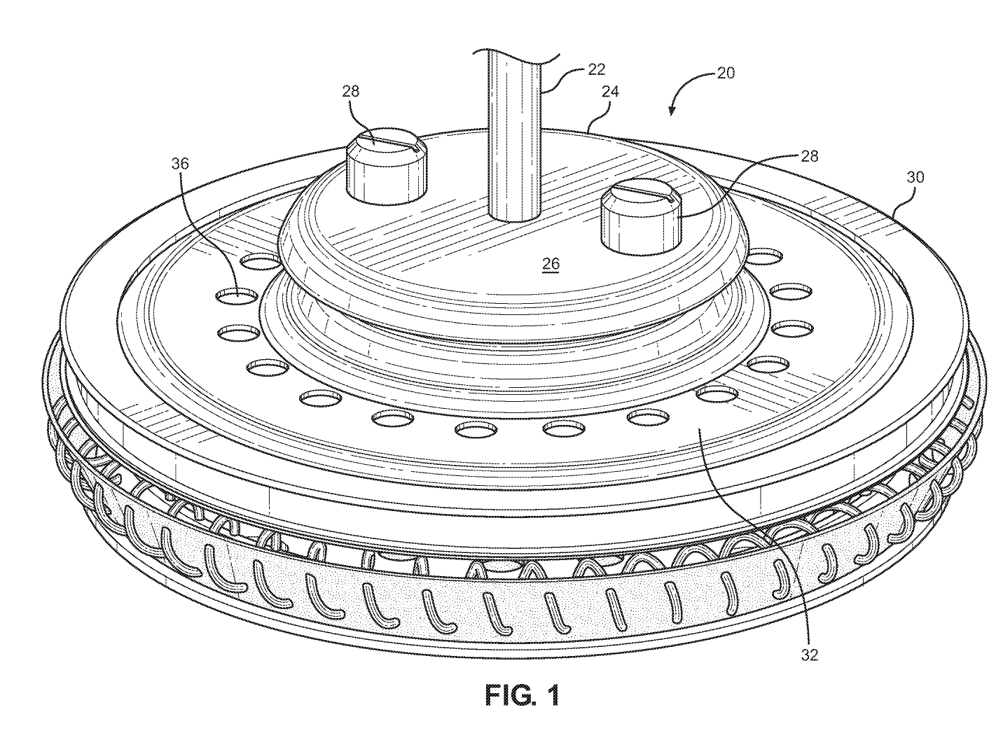

FIG. 2 is a side cross-section perspective view of the two press plates according to one bottom of the present invention.

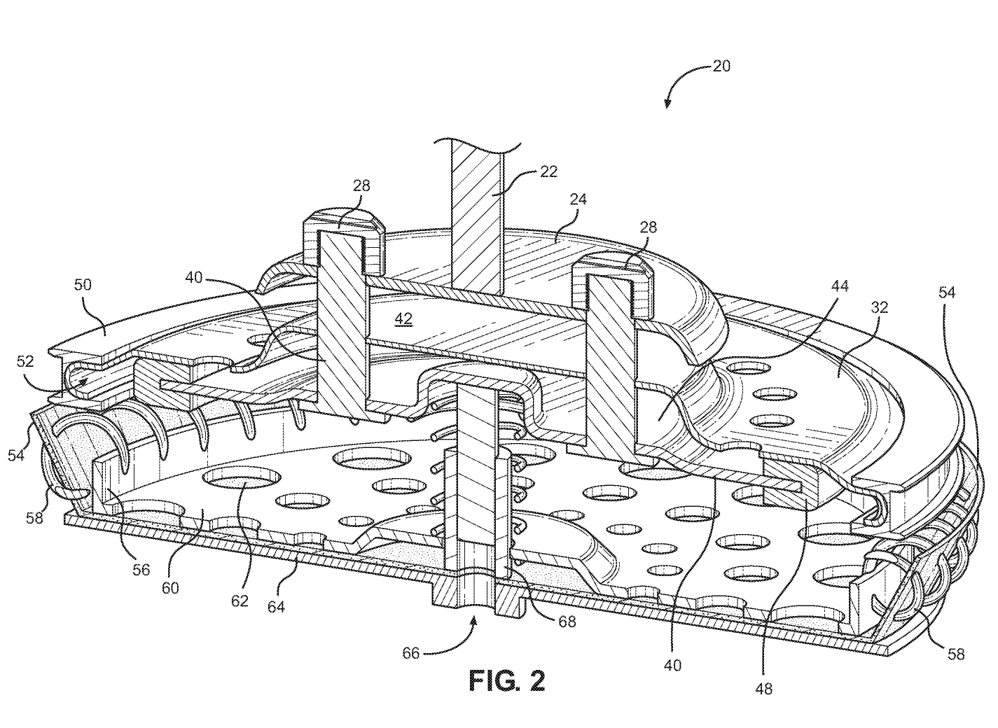

FIG. 3 is a side cross-section view of the two press plates according to one embodiment of the present invention.

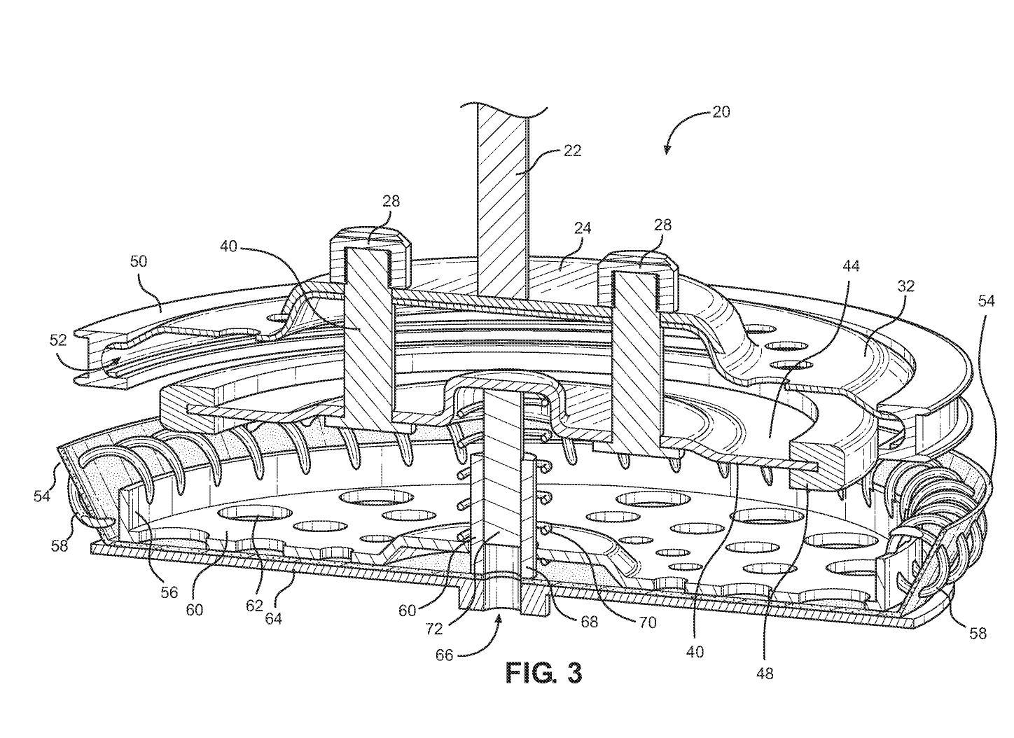

FIG. 4 is a side cross section view of the press plates according to one embodiment of the present invention.

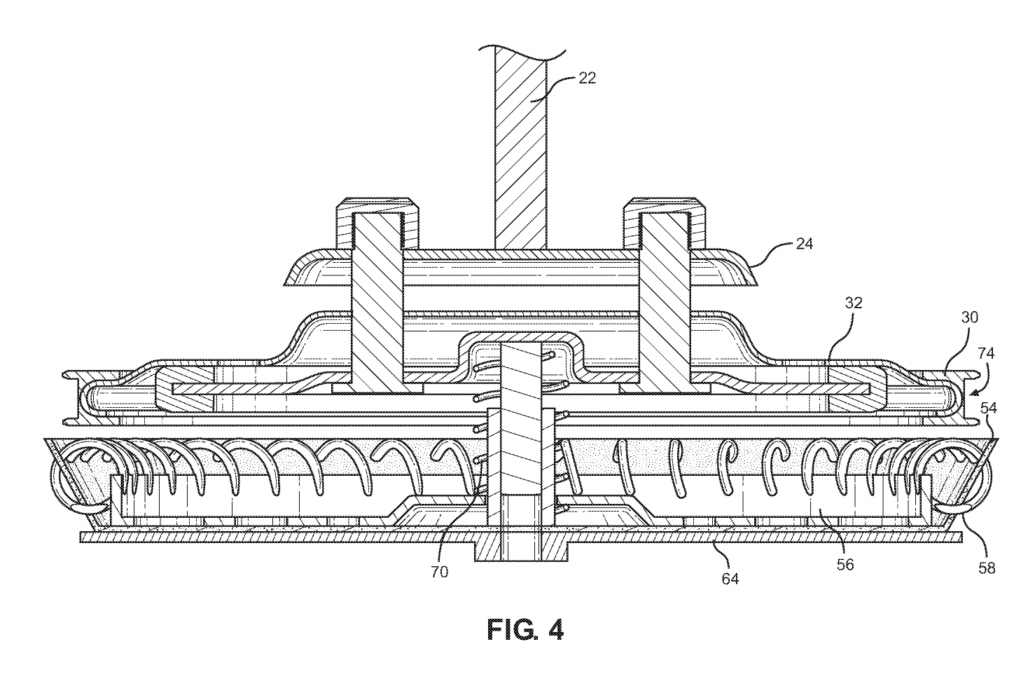

FIG. 5 is a side cross-section view showing separation between the two press plates according to one embodiment the present invention.

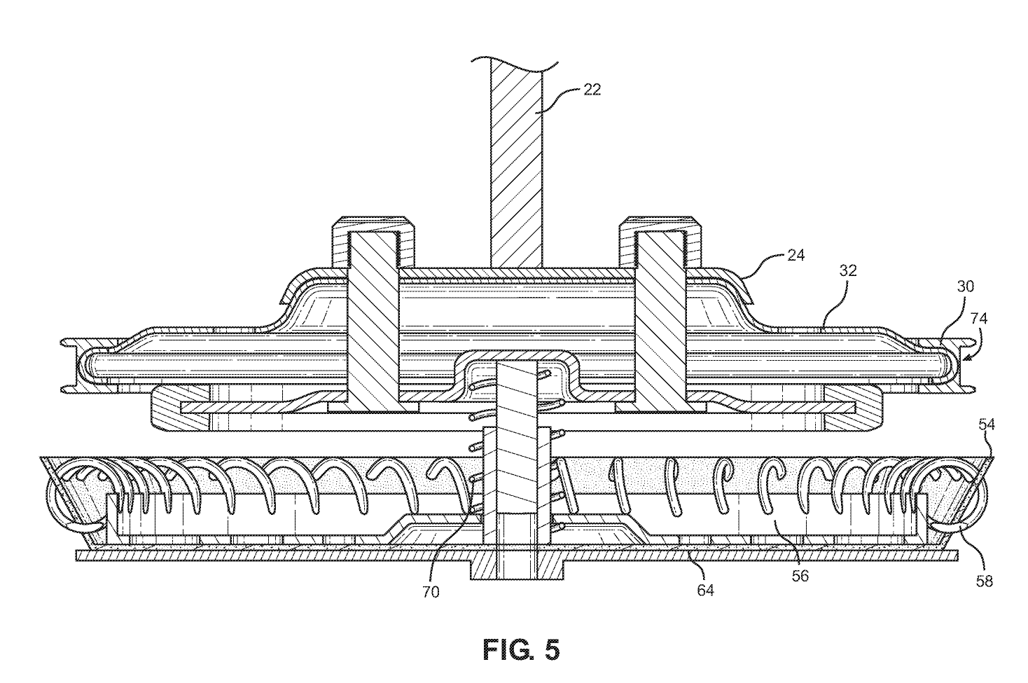

FIG. 6 is a perspective view demonstrating the assembly of the present invention.

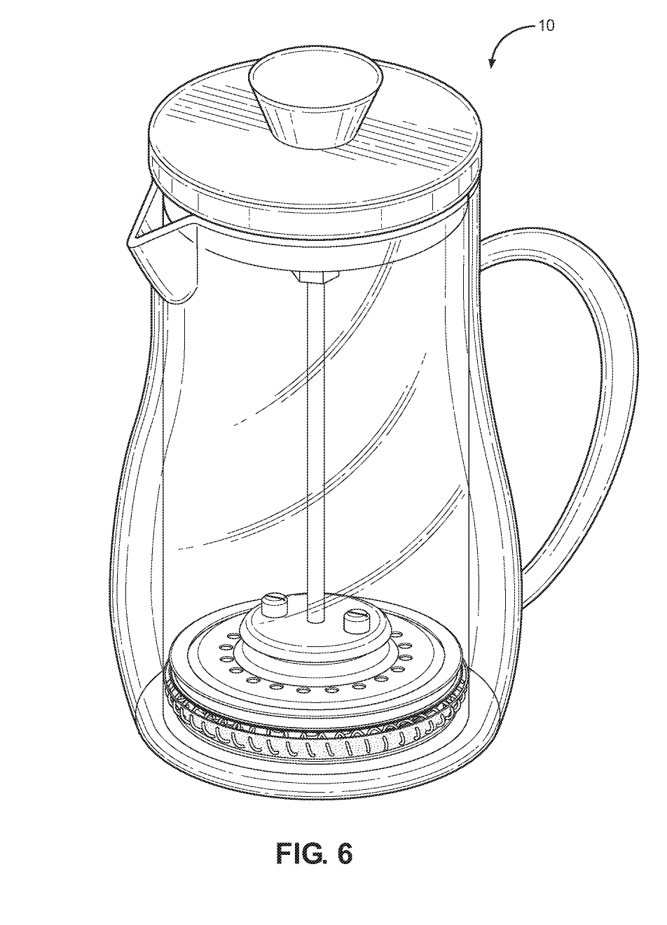

### DETAILED DESCRIPTION OF THE PREFERRED EMBODIMENT

Coffee press assembly 20 includes upper connector plate 26 that is secured into position using locking nuts 28 that secure onto screw posts 40. Upper connecting plate 26 has a circumferential edge 24 that is constructed and arranged to be with in the circumference defined by upper press plate openings 36 formed on upper press plate 32. The assembly further includes a silicone ring 30 around the circumferential edge of upper press plate 32. Upper press plate 32 is further constructed and arranged with central platform 42 positioned above central region 44 of contact plate 42 positioned on the underside of upper press plate 32. Interior silicon ring 48 is formed around the peripheral edge of contact plate 42. Silicon ring 30 is constructed and arranged with proximal cavity 52 whereby proximal cavity 52 being constructed and arranged to mount silicon ring 30 onto upper press plate 32. Silicon ring 30 further has an outer cavity 74 formed thereon.

Lower press plate 60 has formed thereon, lower press plate openings 62 and lower press plate inner spring support wall 56. Lower press plate spring 58 is further supported by lower press mesh 54. The spring for 58 is to extend the mash to make the mash fit to the glass so the coffee doesn't run through. The invention is configured here as a double security as the silicone in 74 also stops the grind from passing through.

Plate 64 is positioned below lower press plate 60 and a stainless steel plate that which keeps the base flat so you can put on the mesh. Plate 64 is also the base where a thread is attached which connects the whole top part to the base.

Central to the system is shaft column 66 positioned on a central axis to assembly 20. Shaft 68 has internal shaft cavity 66 whereby the lower end 72 of shaft 22 slidably moves vertically within internal cavity 66. Main spring 70 is positioned about the exterior of shaft column 68 and urges contact plate 42 upward and away from lower press plate 60.

As generally understood, a user will provide downward pressure emanating from the top of the shaft 22 compressing main spring 70 and moving upper press plate 32 downward onto lower press plate 60. Mesh 64 prevents grinds and other solids from entering into the brewed coffee solution. Additionally, silicon ring 30 is constructed and arranged to prevent sediment from moving up the sides of assembly 20.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A coffee press system comprising
an upper press plate with an outer silicon sealing ring positioned around the circumference edge of said upper press plate;
a contact plate on the underside of said upper press plate positioned, wherein said contact plate has an inner silicon sealing ring positioned around the circumferential edge of said contact plate;
a lower press plate position below said upper press plate and said contact plate, said lower plate formed with a pair of spring walls and circumferential spring formed about the circumferential edge of said lower press plate;
a screen or mesh positioned upward from and above said lower press plate, said screen constructed and arranged to contain solid particulate between said contact plate and lower press plate when the system is in use; and
a spring-loaded central shaft positioned between said lower press plate and said contact plate whereby said spring-loaded central shaft is urged upward from said lower press plate towards said contact plate by a central spring.

2. The system of claim 1 further comprising a container constructed and arranged to mate with said system.

3. The system of claim 1 wherein said screen or mesh is urged outward from the center of said system by a mesh spring.

4. The system of claim 1 wherein said central spring includes one or more springs acting in concert.

5. A method of preparing coffee, said method comprising the steps of:
providing a system of claim 1;
adding coffee to said system on top of said lower press plate;
positioning said system in a container of water, wherein said container is constructed and arranged to receive said system;
applying pressure on said central spring from a direction above said system in a direction of said lower press plate;
maintaining said applying of pressure for time between 30 and 300 seconds;
removing said system from said container while maintaining pressure.
